(19) United States
(12) Patent Application Publication
(10) Pub. No.: US 2020/0088334 A1
(43) Pub. Date: Mar. 19, 2020

(54) Improved Pipe Fitting for Expansion Tanks

(71) Applicant: Zilmet SpA, Limena (PD) (IT)

(72) Inventor: Riccardo Benettolo, Limena (PD) (IT)

(21) Appl. No.: 16/467,960

(22) PCT Filed: Dec. 4, 2017
(86) PCT No.: PCT/IB2017/057608

§ 371 Date: Jun. 8, 2019

(30) Foreign Application Priority Data
Dec. 12, 2016 (IT) 102016000125230

(51) Int. Cl. F16L 37/098; F24D 3/10

(52) U.S. Cl. CPC F16L 37/098; F24D 3/1008

(57) ABSTRACT

A pipe fitting for expansion tanks, suitable for the direct or indirect hydraulic connection with at least one duct of a hydraulic system to an expansion tank, includes a coupling body suited to be permanently constrained to a half shell of the expansion tank and mounted thereon, and an adapter body suited to be permanently constrained to the coupling body and also suited for the direct or indirect connection with the duct of the hydraulic system.

The present patent concerns expansion tanks, and in particular it concerns a new improved pipe fitting for expansion tanks.

Expansion tanks are hydraulic components which are commonly present in boilers for domestic heating, in heating systems and in water supply systems, in which they serve the function of compensating for any volume variation produced by fluid temperature variations in the circuit, thus avoiding dangerous pressure increases in the system itself, which otherwise would be absorbed by the piping and other components of the system.

Expansion tanks are commonly present also in pumping systems and fluid rising systems, in which they serve the function of accumulating the fluid of the circuit in order to successively allow it to return into the circuit itself.

Expansion tanks also serve to protect systems from sudden pressure variations due to instant interruptions of the flow, with the consequent generation and propagation of water hammering.

Expansion tanks are known which comprise two rigid dome-shaped half shells, usually made of a metallic material, opposite and joined to each other in such a way as to form a closed casing.

Inside the tank there is a membrane which subdivides its internal space into two distinct compartments respectively intended to contain the compressible gas which serves to compensate for the increase in the volume of the system fluid and the incompressible fluid which is subject to volume variations.

The half shell intended to contain the fluid of the system is provided with a pipe fitting which communicates with the inner compartment and is suited to connect the compartment itself to the hydraulic circuit.

The other one of the two half shells, instead, is provided with a valve holder with a preload valve for adjusting the gas pressure.

Said half shells of the expansion tanks known in the art are usually made of a metallic material, typically stainless steel, and they can even be internally covered with polymeric materials.

Said pipe fitting is generally constituted by an axially holed cylindrical body, wherein the diameter of the axial hole determines the useful diameter of the passage through which the liquid flows.

Said cylindrical body comprises a first end intended to be constrained to the respective half shell at the level of a hole made in the half shell itself.

For example, said first end comprises an annular portion constrained in any way to the inside of the half shell, typically through a welding operation.

Said cylindrical body comprises a second end opposite said first end and suitable for connection to a pipe belonging to the hydraulic system.

For example, said second end is threaded so that a duct, or a further threaded element for connection with the duct, can be screwed therein.

Otherwise, said second end is especially shaped so that it can become engaged with a duct or with a further element for connection with the duct.

The shape and size of said second end depend on the type of duct to be connected or on the type of pipe fitting used.

The production of the expansion tank is therefore necessarily diversified according to the type of hydraulic system in which the expansion tank is going to be installed. Consequently, the number of pieces to be produced depends on the needs, which prevents the production process of expansion tanks from being optimized.

The patent document DE19740674 concerns an expansion tank in which the pipe fitting comprises an external portion integral with the wall of the expansion tank and an internal cylindrical portion simply inserted and constrained into the cylindrical hole provided in the external portion and projecting from the latter with an externally threaded end. The internal portion is made of a metallic material, while the external portion is made of plastic. The two portions are therefore joined by means of bonding agents.

The patent document EP0779477 concerns an expansion tank in which the pipe fitting is made up of various parts, and wherein the most external part comprises a pair of ducts suited to separately convey the inbound and the outbound flow. The most internal component comprises an external flange and some projections intended to separate the duct of the expansion tank into two separate ducts, respectively for the inbound and the outbound flows. Inside the expansion tank there is a further internal element which in turn is made up of two plastic portions: a main portion resting on the internal wall of the expansion tank and a wall. The pipe fitting is thus made up of at least four parts.

None of the documents mentioned above solves the technical problem of providing a pipe fitting which can be easily adapted to the type of duct to be connected to the expansion tank.

The subject of the present patent is a new type of improved modular pipe fitting. It is the main object of the present invention to resolve the drawbacks of the pipe fittings presently known in the art, in order to allow the new pipe fitting to be adapted to the type of duct to be connected.

It is another object of the present invention to optimize production by developing a production process of the expansion tank which is independent of the type of hydraulic connection to be obtained.

These and other direct and complementary objects are achieved by the new type of improved modular pipe fitting, which in its main parts comprises:

a first coupling body suited to be permanently constrained to the half shell of the expansion tank, and a second adapter body suited to be permanently constrained to said coupling body once the latter has been mounted on said expansion tank, and wherein said second adapter body is suitable for the direct or indirect connection to a duct of a hydraulic system.

Said coupling body is conveniently made of a metallic material and is suited to be welded in any way to the half shell of the expansion tank.

Said adapter body, instead, is made of a plastic or metallic material.

Said first coupling body is substantially cylindrical and axially holed, with a first end suited to be constrained into the hole provided in the half shell of an expansion tank. For example, said end comprises a radial annular edge suited to be welded on the inside or the outside of the edge of the hole provided in the half shell.

Said adapter body is substantially cylindrical and provided with an axial through hole, and it comprises a first engagement portion suited to be inserted and constrained into said axial through hole provided in said coupling body, and a second connecting portion.

Said engagement portion is provided with fixing means suited to fix it to said coupling body. In particular, said adapter body is suited to be constrained to said coupling body in such a way as to prevent it from coming off and from rotating with respect to the coupling body.

Said connecting portion of said adapter body comprises variously shaped parts suitable for the direct or indirect connection with the duct of the hydraulic system in which the expansion tank will be installed.

The assembly of the new pipe fitting includes the step of mounting said coupling body on the half shell of the expansion tank.

Said first coupling body is welded to the inside or to the outside of the edge of the hole provided in the half shell.

Once said coupling body has been constrained to the respective half shell, it is also possible to complete the production and assembly of the expansion tank.

Said adapter body, instead, can be the last to be assembled, through its insertion and engagement into said coupling body. In this way, the coupling body and the expansion tank can have standard sizes and their production process is optimized independently of the type of hydraulic system in which the expansion tank will be installed and of the type of duct to which the expansion tank will be connected.

The adapter body, instead, is produced according to the users' requests, and can be assembled onto said coupling body before delivery to the user.

In particular, said engagement portion is a standard element suited to be engaged into the coupling body, while said connecting portion is shaped and sized according to the needs. Said coupling body and said adapter body are tightly assembled together, for example through the interposition of an O-ring between said coupling body and said adapter body. The characteristics of the new pipe fitting will be highlighted in greater detail in the following description, making reference to the drawings which are attached hereto by way of non-limiting example.

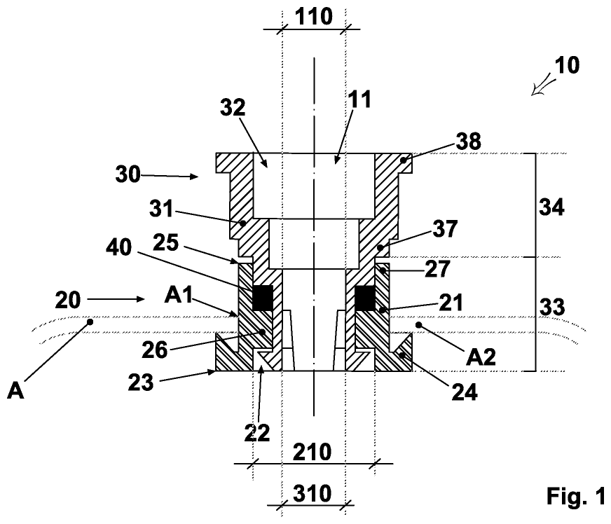

FIG. 1 shows a cross-sectional view of the new pipe fitting (10), completely assembled and constrained to a half shell (A) of an expansion tank.

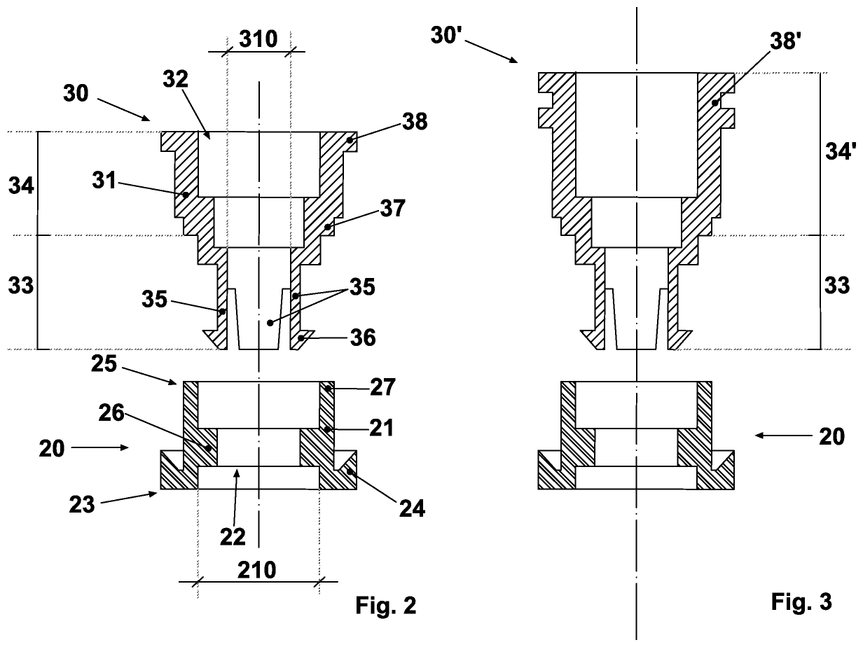

FIG. 2 shows a cross-sectional view of the new pipe fitting (10) in its separate parts (20, 30).

FIG. 3 shows a cross-sectional view of the new pipe fitting (10) in its separate parts (20, 30′), wherein the adapter body (30′) is made with a connecting portion (34′) shaped in a different manner.

The improved pipe fitting (10) which is the subject of the present patent is suited to be used in an expansion tank consisting of two half shells. In FIG. 1 a part of the half shell (A) to which said pipe fitting (10) is constrained is represented with broken lines.

The new pipe fitting (10) comprises a first coupling body (20) suited to be permanently constrained to the half shell (A) of the expansion tank, as well as a second adapter body (30) suitable for the direct or indirect connection with a duct of a hydraulic system.

Said adapter body (30) is suited to be permanently constrained to said first coupling body (20) once said coupling body (20) has been mounted on said half shell (A) of the expansion tank.

Said coupling body (20) comprises a substantially cylindrical body (21) provided with an axial hole (22).

Said coupling body (20) comprises a first end (23) suited to be constrained to the hole (A1) provided in the half shell (A) of an expansion tank, and a second opposite open end (25) suitable for the insertion of said adapter body (30).

In the example illustrated in FIG. 1, said first end (23) is inserted in said hole (A1) provided in the half shell (A).

Said first end (23) comprises at least one flange or radial annular edge (24) which is suited to be welded to the inside or the outside of the edge (A2) of the hole (A1) provided in the half shell (A).

As shown in FIG. 1, with the coupling body (20) welded to the half shell (A), a part of said coupling body (20) projects from the hole (A1) provided in the half shell (A), in such a way that its end (25) can be accessed for the insertion of said adapter body (30). Said adapter body (30) comprises a substantially cylindrical body (31) provided with a through axial hole (32) and comprising an engagement portion (33) suited to be inserted in said through axial hole (22) provided in said coupling body (20), as well as a connecting portion (34) suitable for connection with the hydraulic system.

The insertion of said adapter body (30) in said coupling body (20) forms the axial hole (11) of the pipe fitting (10), which places the outside of the expansion tank in communication with the inside of the same.

The useful diameter (110) of said axial hole (11) of the pipe fitting (10) is the useful diameter for the passage of the liquid.

In particular, said useful diameter (110) of the axial hole (11) provided in the pipe fitting (10) coincides with the diameter (310) of said axial hole (32) provided in said adapter body (30). Therefore, the diameter (210) of said coupling body (20) is larger than said useful diameter (110), since it has to allow for the insertion of said adapter body (30).

Said engagement portion (33) of said adapter body (30) is provided with flexible tabs (35) arranged longitudinally, that is, in the axial direction, and provided with radial locking teeth (36) suited to interfere with correspondingly shaped portions located inside said axial hole (22) of said coupling body (20).

For example, inside said axial hole (22) of said coupling body (20) there is an annular projection (26) which protrudes towards the inside of the hole itself (22) and is intended to be coupled with said teeth (36) of the adapter body (30).

Said connecting portion (34) comprises shaped parts (38) for the direct or indirect connection with the hydraulic system in which the expansion tank will be installed.

Said open end (25) of said coupling body (20), through which said adapter body (30) is inserted, is preferably provided with longitudinal anti-rotational projections or tabs (27), suited to be engaged in corresponding seats created in a corresponding portion of said adapter body (30), for example in an annular projection (37) created on said cylindrical body (31).

Said coupling body (20) and said adapter body (30), once assembled together, are tight, for example owing to the interposition of an 0 ring (40) between said coupling body (20) and said adapter body (30).

For example, said O ring (40) is arranged between said annular projection (26) inside the axial hole (22) provided in said coupling body (20) and an annular projection (39) created on said engagement portion (33) of said adapter body (30).

In the example illustrated in FIG. 3, said adapter body (30′) comprises a connecting portion (34′) shaped in a different manner, for example longer and provided with specifically shaped parts (38′).

Therefore, with reference to the above description and the attached drawings, the following claims are expressed.

1. A pipe fitting (10) for expansion tanks, suitable for a direct or indirect hydraulic connection with a duct of a hydraulic system, said pipe fitting (10) comprising:
a coupling body (20) adapted to be permanently constrained to a half shell (A) of an expansion tank and comprising a substantially cylindrical body (21) provided with a first axial hole (22);
an adapter body (30) adapted to be permanently constrained to said coupling body (20), said coupling body being mounted on said half shell (A),
wherein said adapter body (30) is adapted for the direct or indirect connection with said duct of the hydraulic system,
wherein said coupling body (20) is made of a metallic material and is suited to be welded to the half shell (A) of the expansion tank,
wherein said adapter body (30) is made of a plastic or metallic material, and
wherein said adapter body (30, 30′) comprises,
a substantially cylindrical body (31) provided with a second axial hole (32) and comprising an engagement portion (33) adapted to be inserted in the first axial hole (22) of said coupling body (20), and
a connecting portion (34, 34′) adapted to be connected to the hydraulic system, wherein said connecting portion (34, 34′) comprises shaped parts (38, 38′) for the direct or indirect connection with the duct of the hydraulic system in which the expansion tank will be installed, said shaped parts (38, 38′) being sized and shaped according to the duct to be connected.

2. The pipe fitting (10) according to claim 1, wherein said coupling body (20) comprises a substantially cylindrical body (21) which is holed axially (22) and has a first end (23) configured to be constrained to a hole (A1) of the half shell (A) of the expansion tank, and a second opposite open end (25) configured to project from said hole (A1) of the half shell and to receive said adapter body (30), and wherein said first end (23) comprises at least one radial annular edge (24) adapted to be welded to an edge (A2) of the hole (A1) of the half shell (A).

3. The pipe fitting (10) according to claim 1, wherein a diameter (310) of said second axial hole (32) of said adapter body (30, 30′) is sized to define a passage through which a liquid flows.

4. The pipe fitting (10) according to claim 1, wherein said engagement portion (33) of said adapter body (30) and said coupling body (20) comprise mutual constraining means (35, 36, 37, 26, 17) adapted to prevent a withdrawal and a relative rotation between said adapter body (30) and said coupling body (20).

5. The pipe fitting (10) according to claim 4, wherein said engagement portion (33) of said adapter body (30) is equipped with longitudinal flexible tabs (35) provided with radial locking teeth (36) configured to interfere with parts or projections (26) located inside said first axial hole (22) of said coupling body (20).

6. The pipe fitting (10) according to claim 2, wherein said open end (25) of said coupling body (20), through which said adapter body (30) is inserted, is provided with longitudinal anti-rotational projections or tabs (27) configured to be fitted in corresponding seats made in corresponding parts or projections (37) defined in said adapter body (30).

7. The pipe fitting (10) according to claim 1, wherein said coupling body (20) and said adapter body (30) are assembled together in tight manner.
